(19) United States
(12) Patent Application Publication
(10) Pub. No.: US 2010/0146990 A1
(43) Pub. Date: Jun. 17, 2010

(54) THERMOELECTRIC COOLER FOR COMPRESSOR MOTOR

(76) Inventors: Michael F. Taras, Fayetteville, NY (US); Alexander Lifson, Manlius, NY (US); Richard G. Lord, Murfeesboro, TN (US)

Correspondence Address: CARLSON, GASKEY & OLDS, P.C., 400 WEST MAPLE ROAD, SUITE 350, BIRMINGHAM, MI, 48009, US

(21) Appl. No.: 12/600,507

(22) PCT Filed: Aug. 14, 2007
(86) PCT No.: PCT/US07/75847

§ 371 Date: Nov. 17, 2009

(51) Int. Cl. F25B 21/02; H02K 9/00; F25B 1/00; F25D 17/06; F04B 35/04

(52) U.S. Cl. 62/3.2; 310/52; 62/498; 62/426; 62/115; 417/410.1

(57) ABSTRACT

A refrigerant system has an electric motor positioned either inside or outside of a hermetically sealed shell containing a compressor pump unit and is mechanically coupled to drive this compressor pump unit. The electric motor has at least one thermoelectric cooler to cool, or assist in cooling, of at least one component of the electric motor.

### BACKGROUND OF THE INVENTION

This application relates to a refrigerant system having a compressor and a thermoelectric device providing at least partial cooling for a compressor motor.

Refrigerant compressors compress and circulate a refrigerant throughout a refrigerant system to condition a secondary fluid that is typically delivered into a climate-controlled space. Typically, in a basic refrigerant cycle, a compressor compresses a refrigerant and delivers it to a heat rejection heat exchanger. An electric motor typically drives the compressor. Refrigerant from the heat rejection heat exchanger passes through an expansion device, in which its pressure and temperature are reduced. Downstream of the expansion device, the refrigerant passes through a heat accepting heat exchanger, and then back to the compressor. As known, the heat accepting heat exchanger is typically an evaporator. The heat rejecting heat exchanger is a condenser, for subcritical applications, or a gas cooler, for transcritical applications.

The electric motor and compressor pump unit are often mounted within a permanently sealed hermetic shell. These compressor configurations are called hermetic compressors. In such arrangements, at least a portion of the refrigerant quite often is directed into the shell to initially pass over the compressor motor to cool the motor. The motor can be cooled by refrigerant at suction, intermediate or discharge locations. Most often, the motor is located within the compressor shell on the suction side. As can be appreciated, the electric motors reach high temperatures during operation of the refrigerant system, especially at operating conditions when the compressor load is high or/and refrigerant flow is low. Various safety devices, such as shutdown devices, stop the operation of the motor, and hence the compressor, should the motor become unduly hot. Such protection devices are known in the art, and include for instance, bi-metal switches or temperature sensors activated devices. In these fully hermetically sealed compressors, the suction refrigerant quite often adequately cools the electric motor, although the capacity and efficiency of a refrigerant system is reduced due to refrigerant pre-heating before it enters compression chambers.

Another type of refrigerant compressors also has the electric motor and compressor pump unit mounted within a hermetically sealed shell, but this compressor assembly can be taken apart. Such compressor configurations are called semi-hermetic compressors. For semi-hermetic compressors, and especially large centrifugal and screw compressors, it is difficult to achieve uniform motor cooling by primary refrigerant circulating throughout the system. Since the motor is often located in a separate cavity, and refrigerant does not naturally flow over it, special design arrangements, such as refrigerant flow passages in the rotor and additional penetration through the compressor shell to redistribute refrigerant, must to be made. Rotor rotational motion and non-uniform winding structure aggravate the problem and make it difficult to eliminate hot spots within the compressor stator windings.

Another type of refrigerant compressor has only the compressor pump unit located within a hermetically sealed shell. The electric motor is positioned outwardly of the shell. These compressors are called open-drive compressors. In such systems, some other arrangement for cooling the motor is necessary. It is known to circulate a cooling fluid through passages in the motor stator or around the compressor shell. The cooling fluid may be air or some other fluid.

In many cases, attempts to cool the motor have not proven satisfactory, cost effective, simple in design or efficient in operation. Thus, there exist localized hot spots within the motor that can result in nuisance shutdowns of the motor and hence the compressor, or permanent motor damage.

One option which has been recently proposed for incorporation into refrigerant systems is the use of thermoelectric coolers. The thermoelectric cooler essentially takes advantage of specific thermoelectric properties of dissimilar semiconductor materials and is based on two phenomena—the Peltier effect and Seebeck effect, concurrently taking place during operation of the thermoelectric device. The Peltier effect is associated with the release or absorption of a finite heat flux at the junction of two electrical conductors, made from different materials and kept at constant temperature, at the presence of electric current. Similarly, the Seebeck effect is related to the same arrangement, where the two junctions are maintained at different temperatures, which would create a finite potential difference, and an electromotive force that would drive an electric current in the closed-loop electric circuit.

The Peltier and Seebeck effects are presented simultaneously in the thermoelectric cooler that is preferably made from materials that have dissimilar absolute thermoelectric powers. The finite electric current passing through the two junctions triggers two heat transfer interactions with two cold and hot reservoirs kept at different temperatures. For steady thermoelectric cooler operation, heat fluxes associated with the two junctions should have opposite signs. If the external system maintains potential difference and drives electric current against this difference, the two junction system becomes a thermoelectric cooling device.

A typical thermoelectric cooler consists of an array of P-type and N-type semiconductor elements that act as the two dissimilar conductors. The P-type material has an insufficient number of electrons and the N-type material has extra electrons. These electrons in the N-type material and so-called “holes” in the P-type material, in addition to carrying an electric current, become a transport media to move the heat from the cold junction to the hot junction. The heat transport rate depends on the current passing through the circuit and the number of moving electron-hole couples. As an electric current is passed through one or more pairs of P—N elements, there is a decrease in temperature at the cold junction resulting in the absorption of heat from the object to be cooled. The heat is carried through the thermoelectric cooler by electron transport and released at the hot junction as the electrons move from a high to a low energy state.

Although the thermoelectric devices are inherently irreversible, since heat and electric current must flow through the circuit during their operation, they do not have moving parts that makes them extremely reliable.

Thermoelectric devices have not been applied to motor cooling.

### SUMMARY OF THE INVENTION

In the disclosed embodiment of this invention, a compressor of a refrigerant system has a mechanically coupled electric motor that is at least partially cooled by at least one thermoelectric cooler having its cold junction placed adjacent to at least one hot spot of a stator for the electric motor. The compressor may be a hermetic, semi-hermetic, or open-drive compressor. An auxiliary device, such as a fan, may be positioned to pass a secondary fluid over the hot junction of the thermoelectric cooler.

These and other features of the present invention can be best understood from the following specification and drawings, the following of which is a brief description.

### BRIEF DESCRIPTION OF THE DRAWINGS

FIG. 1 schematically shows a refrigerant system incorporating the present invention.

FIG. 2 shows the FIG. 1 embodiment.

FIG. 3 shows a second embodiment.

### DETAILED DESCRIPTION OF THE PREFERRED EMBODIMENTS

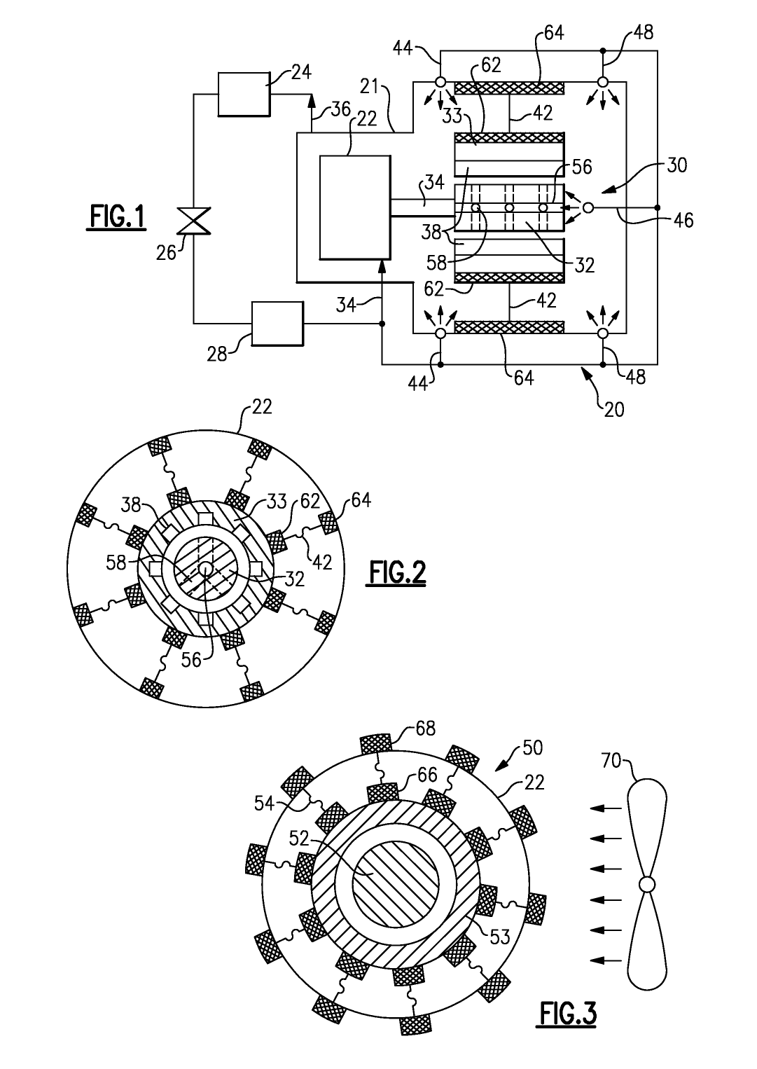

FIG. 1 shows a refrigerant system 20 incorporating a sealed compressor shell 22 housing a compressor pump unit, shown schematically in outline at 21. The compressor pump unit 21 is driven by an electric motor 30 that is mechanically coupled to the compressor pump unit 21 and may be also positioned within the sealed compressor shell 22.

When both the electric motor 30 and compressor pump unit 21 are mounted within a single permanently sealed hermetic shell 22, these compressor configurations are called hermetic compressors. In such arrangements, at least a portion of refrigerant flow quite often is directed into the shell to initially pass over the compressor motor to cool the motor. As mentioned above, electric motors reach high temperatures during operation of the refrigerant system, especially at operating conditions when the compressor load is high or/and refrigerant flow is low. The motor can be cooled by the refrigerant on the suction side or intermediate location (in case of a multi-stage or vapor injection compressor design). Typically, the motor is cooled by the refrigerant on the suction side. However, often the amount of motor cooling proved to be inadequate causing motor reliability problems and nuisance shutdowns. Therefore it would be beneficial to provide other alternate or supplemental means to cool electric motors for hermetic refrigerant compressors.

Another type of refrigerant compressors also has an electric motor and compressor pump unit mounted within a single hermetically sealed shell, but this compressor assembly can be taken apart. Such compressor configurations are called semi-hermetic compressors. For semi-hermetic compressors, and especially large centrifugal and screw compressors, it is difficult to achieve uniform motor cooling by primary refrigerant circulating throughout the system. Since the motor is often located in a separate cavity, and refrigerant does not naturally flow over it, special design arrangements, such as refrigerant flow passages in the rotor and additional penetration through the compressor shell to redistribute refrigerant, have to be made. Rotor rotational motion and non-uniform winding structure aggravate the problem and make it difficult to eliminate the hot spots within the compressor stator windings.

For the open-drive compressors, a shaft 34 connecting the compressor pump 21 unit and electric motor 30 has to protrude through the compressor shell 22 and be sealed to prevent refrigerant and oil escape from the refrigerant system 20. Although in open-drive configurations a secondary fluid such as air can pass over the compressor motor components to cool them during operation, and especially at high load conditions, the compressor motor can reach very high temperatures that are detrimental for electric motor reliability and environmental safety. High temperature spots within electric motors driving refrigerant compressors can be extremely localized, e. g. within the stator windings for the electric motor.

Although a hermetic compressor configuration is shown in relation to the preferred embodiment of the disclosure, other compressor configurations, such as semi-hermetic and open-drive compressors, can equally benefit from the disclosure.

Returning to FIG. 1, where the example is provided for a motor to be cooled by a flow of refrigerant at the compressor suction, refrigerant passes from the compressor unit hermetically sealed shell 22 to an outlet discharge line 36, and to a downstream heat exchanger 24. From the heat exchanger 24, the refrigerant passes through an expansion device 26, and another heat exchanger 28. Typically, the heat exchanger 24 is a heat rejection heat exchanger, and the heat exchanger 28 is a heat accepting heat exchanger. Refrigerant, downstream of the heat exchanger 28, passes through a suction line 34 back into the sealed compressor shell 22. The electric motor 30 has a rotor 32 mechanically coupled to the shaft 34 to drive the compressor pump unit 21, as known. Any other mechanical coupling arrangement, such as gears, can be used instead of the shaft 34.

As shown, a stator 33 surrounds the rotor 32. The stator 33 becomes hot during operation of the electric motor 30, since an electric current passes through the stator windings. Cooling fluid passages 38 quite often are supplied within the rotor, the stator and internal elements of the compressor shell 22. The cooling fluid may be the refrigerant from the refrigerant system 20, or may be some other fluid. As shown in FIG. 1, refrigerant lines 44, 46 and 48 route at least a portion of suction refrigerant through the electric motor cavity to cool the motor, prior to entering the compression chambers of the compressor pump 21. For instance, the refrigerant lines 44 and 48 are located at the periphery of the stator 33 and cool it from the outside, while the refrigerant line 46 initially passes a portion of suction refrigerant through a passage 56 in the rotor 32 and then distributes it through the openings 58 to cool the stator 33 from the inside. Obviously, additional penetrations are to be made through the hermetically sealed shell 22. As mentioned above, even with this arrangement, there quite often exist localized hot spots within the stator 33 of the electric motor 30, at certain circumferential or longitudinal locations between the passages 38. The cold junctions 62 of thermoelectric coolers 42 are strategically positioned at these locations. There are may be a single or multiple thermoelectric cooling devices 42. For instance, as shown in FIG. 1, the cold junctions 62 for the thermoelectric cooling devices 42 may be positioned on the periphery of the stator 33. As can be appreciated, the cold junctions 62 of the thermoelectric coolers 42 are placed in contact with the stator 33, and the hot junctions 64 face outwardly, or may be located outside of the compressor shell 22. In the latter case, secondary cooling devices such as fans may be employed to move a cooling fluid (air, in this case) over the hot junctions 64 of the thermoelectric coolers 42.

As shown in FIG. 2, the thermoelectric coolers 42 may be positioned circumferentially intermediate the location of the cooling passages 38. The cold junctions 62 of the thermoelectric coolers 42 need not be positioned in a regular pattern. For instance, they may be associated with the high current density spots, such as electrical connections penetrating through the compressor shell 22. In the FIG. 2, both cold junctions 62 and hot junctions 64 of the thermoelectric coolers 42 are positioned within the shell 22. On the other hand, as shown in FIG. 3, in an embodiment 50, the rotor 52 and stator 53 is not provided with any cooling fluid passages. Instead, the thermoelectric coolers 54 are utilized and responsible for providing the entire cooling.

In the FIG. 3, cold junctions 66 of the thermoelectric coolers 54 are located within the shell 22, while the hot junctions are located outside the shell 22 and may be cooled by a fan 70. Special arrangements and penetrations through the compressor shell 22 are to be made to accommodate positioning of the cold and hot junctions of the thermoelectric coolers 54 on opposite side of the shell 22. Thermoelectric coolers 42 and 54 can be associated with any other component of an electric motor. The thermoelectric coolers can also be actuated on demand only, when additional motor cooling is desired.

This invention applies to various types of compressors including centrifugal, scroll, screw, and reciprocating type. It can also be used with a variety of refrigerants, including but not limited to R134a, R410A, R404A, R22, R407C, and R744. It can also be employed with different types of motors, such as induction motors, switched reluctance motors, permanent magnet motors, etc. It can also be applied in a variety of refrigerant systems, including but not limited to container refrigeration applications, truck-trailer applications, rooftop units, residential air conditioning and heat pump units and supermarket refrigeration applications.

While embodiments of this invention have been disclosed, a worker of ordinary skill in this art would recognize that certain modifications would come within the scope of this invention. For that reason, the following claims should be studied to determine the true scope and content of this invention.

We claim:

1. A refrigerant system compressor comprising:
a compressor pump unit positioned within a hermetically sealed shell;
an electric motor coupled with said compressor pump unit to drive said compressor pump unit, said electric motor including a stator and a rotor; and
at least one thermoelectric cooler having a cold junction placed to cool at least one hot spot within at least one component of said electric motor.

2. The refrigerant system compressor as set forth in claim 1, wherein said compressor is disposed in the refrigerant system that also includes a first heat exchanger downstream of said compressor, an expansion device downstream of said first heat exchanger, and a second heat exchanger downstream of said expansion device, refrigerant circulating from said compressor pump unit, through said first heat exchanger, said expansion device, said second heat exchanger, and back to said compressor pump unit.

3. The refrigerant system compressor as set forth in claim 1, wherein said at least one thermoelectric cooler is providing primary cooling for said electric motor.

4. The refrigerant system compressor as set forth in claim 1, wherein said at least one thermoelectric cooler is providing supplementary cooling for said electric motor.

5. The refrigerant system compressor as set forth in claim 1, wherein said at least one thermoelectric cooler is providing supplementary cooling for said electric motor and said thermoelectric cooler is activated on demand.

6. The refrigerant system compressor as set forth in claim 1, wherein said at least one thermoelectric cooler is associated with said stator of said electric motor.

7. The refrigerant system compressor as set forth in claim 1, wherein said electric motor is also positioned within said hermetically sealed shell for said compressor pump unit.

8. The refrigerant system compressor as set forth in claim 7, wherein a hot junction of said at least one thermoelectric cooler is also positioned within said hermetically sealed shell for said compressor pump unit.

9. The refrigerant system compressor as set forth in claim 7, wherein a hot junction of said at least one thermoelectric cooler is positioned outside of said hermetically sealed shell for said compressor pump unit.

10. The refrigerant system compressor as set forth in claim 1, wherein there are a plurality of circumferentially spaced thermoelectric coolers.

11. The refrigerant system compressor as set forth in claim 1, wherein there are a plurality of cooling fluid passages formed within at least one component of said electric motor.

12. The refrigerant system compressor as set forth in claim 11, wherein said at least one component of said electric motor is one of the stator, rotor or hermetically sealed shell.

13. The refrigerant system compressor as set forth in claim 11, wherein said cooling fluid passages receive a fluid other than refrigerant.

14. The refrigerant system compressor as set forth in claim 11, wherein said cooling fluid passages receive primary refrigerant as a cooling fluid.

15. The refrigerant system compressor as set forth in claim 1, wherein a fan is provided to move cooling fluid over a hot junction of said at least one thermoelectric cooler.

16. A method of operating a refrigerant system compressor comprising the steps of:
positioning a compressor pump unit within a hermetically sealed shell;
coupling an electric motor with said compressor pump unit and driving said compressor pump unit, said electric motor including a stator and a rotor; and
providing at least one thermoelectric cooler having a cold junction placed to cool at least one hot spot within at least one component of said electric motor.

17. The method as set forth in claim 16, wherein said compressor is disposed in a refrigerant system that also includes a first heat exchanger downstream of said compressor, an expansion device downstream of said first heat exchanger, and a second heat exchanger downstream of said expansion device, refrigerant circulating from said compressor pump unit, through said first heat exchanger, said expansion device, said second heat exchanger, and back to said compressor pump unit.

18. The method as set forth in claim 16, wherein said at least one thermoelectric cooler is providing primary cooling for said electric motor.

19. The method as set forth in claim 16, wherein said at least one thermoelectric cooler is providing supplementary cooling for said electric motor.

20. The method as set forth in claim 16, wherein said at least one thermoelectric cooler is providing supplementary cooling for said electric motor and said thermoelectric cooler is activated on demand.

21. The method as set forth in claim 16, wherein said at least one thermoelectric cooler is associated with said stator of said electric motor.

22. The method as set forth in claim 16, wherein said electric motor is also positioned within said hermetically sealed shell for said compressor pump unit.

23. The method as set forth in claim 22, wherein a hot junction of said at least one thermoelectric cooler is also positioned within said hermetically sealed shell for said compressor pump unit.

24. The method as set forth in claim 22, wherein a hot junction of said at least one thermoelectric cooler is positioned outside of said hermetically sealed shell for said compressor pump unit.

25. The method as set forth in claim 16, wherein there are a plurality of circumferentially spaced thermoelectric coolers.

26. The method as set forth in claim 16, wherein there are a plurality of cooling fluid passages formed within at least one component of said electric motor.

27. The method as set forth in claim 26, wherein said at least one component of said electric motor is one of the stator, rotor or hermetically sealed shell.

28. The method as set forth in claim 26, wherein said cooling fluid passages receive a fluid other than refrigerant.

29. The method as set forth in claim 26, wherein said cooling fluid passages receive primary refrigerant as a cooling fluid.

30. The method as set forth in claim 16, wherein a fan is provided to move cooling fluid over a hot junction of said at least one thermoelectric cooler.
